(19) United States
(12) Patent Application Publication
(10) Pub. No.: US 2020/0160391 A1
(43) Pub. Date: May 21, 2020

(54) SYSTEM AND METHOD FOR PROVIDING INFORMATION ABOUT NIGHTCLUBS AND BARS IN A GEOGRAPHICAL AREA

(71) Applicants: Ross E. Dworkin, Springfield, PA (US); Vladimir Bien-Aime, Lansdale, PA (US)

(72) Inventors: Ross E. Dworkin, Springfield, PA (US); Vladimir Bien-Aime, Lansdale, PA (US)

(21) Appl. No.: 16/192,910

(22) Filed: Nov. 16, 2018

(51) Int. Cl. G06Q 30/02; H04W 4/02

(52) U.S. Cl. CPC G06Q 30/0261; G06Q 30/0226; H04W 88/02; G06Q 30/0259; H04W 4/023; G06Q 30/0267

(57) ABSTRACT

A server transmits information, to a plurality of subscribers having mobile devices, concerning bars or nightclubs located within a predetermined distance from each subscriber. Subscribers receive information concerning special offers available at particular establishments. The system also enables subscribers to identify other subscribers, located at establishments in the vicinity, and to communicate with them. By tracking the location of each subscriber, the system can tailor offers to subscribers who are near particular establishments, and/or who have particular preferences, and it can accumulate data from which to generate statistics which help operators of such establishments to maximize profitability.

### BACKGROUND OF THE INVENTION

The present invention relates to the field of providing information to customers or prospective customers of nightclubs and bars, or the like, in a particular geographical area.

Many persons, both single and married, attend nightclubs and bars. Within a given geographical radius, there may be a number of such nightclubs and bars. At any given moment, a person likely will not know of special promotions being made at certain establishments, and likely will not know about acquaintances who may be present at such establishments.

Most persons do not leave their homes without a mobile device, typically a smartphone or tablet computer. Such devices generally have the ability to track their location, by using GPS technology or by other means. The present invention takes advantage of this capability, to provide a mobile application which provides, to its subscribers, valuable information concerning nightclubs and bars in a given region.

The present invention also delivers cost-saving coupons to users visiting a specific bar or nightclub. Such users can see and redeem coupons for financial discounts at these locations, as well as indicate a romantic interest in patrons at these or nearby locations.

The invention is also helpful to owners and operators of bars and nightclubs, enabling them to know more about the purchasing habits of their customers, and enabling them to tailor special offers to those persons most likely to patronize their establishments.

### SUMMARY OF THE INVENTION

The present invention comprises a system and method for providing information about nightclubs or bars in a specific vicinity.

The system includes a central server, having a programmed computer, a plurality of mobile devices carried by subscribers, and a plurality of computers or other devices associated with operators of the various bars or nightclubs.

According to the invention, subscribers register with the system, providing personal profile information which is then stored in the central server. The operators of the bars or nightclubs can also provide information about their respective establishments. In the absence of bar or nightclub participation, the system can obtain information provided by any of various commercial databases, such as Google Places, Foursquare, etc.

Using a location-monitoring algorithm, such as a GPS system or equivalent, the system continuously monitors the location of the mobile device of each subscriber. Thus, the system can transmit, to the mobile devices of subscribers, information about bars or nightclubs located within a predetermined distance from such mobile device. Information about which bars or nightclubs are within a given distance from the mobile device is continuously updated, as the subscriber changes location.

The system is programmed to accept preferred criteria from subscribers, and to display to the mobile device of each subscriber, information on bars or nightclubs, within a predetermined distance, which satisfy such criteria.

The system also displays, to each subscriber, information about other subscribers who are in the vicinity, and enables a subscriber to communicate with other subscribers by text message. The system also includes a feature wherein a subscriber, typically female, can restrict the ability of other subscribers, typically male, to obtain information about that subscriber.

From the point of view of the operators of the bars or nightclubs, the system enables such operators to create, store, and transmit to subscribers, special offers and promotions, to entice subscribers to patronize a particular establishment. Such offers may be extended to subscribers who are within a predetermined distance of the bar or nightclub, and/or who satisfy various predetermined criteria set forth by the operator. The special offers may take the form of an electronic discount coupon, which a subscriber may redeem at one of the establishments.

In one preferred embodiment, the system is programmed to advertise special offers, to a subscriber, when the subscriber is at or near the establishment making the offer. The system is also programmed to monitor the movements of subscribers more closely when the subscriber appears to be moving towards an establishment issuing the special offer.

The system also records data concerning the location of each subscriber, at each time, and uses this information to compile statistics concerning how many subscribers patronized a given bar or nightclub, during a particular interval, and how many subscribers redeemed a particular special offer. This information can be presented to operators of the establishments, for use in formulating a strategy for generating special offers in the future. The system also uses the above-described stored data to predict how many subscribers will patronize a particular bar or nightclub, at a particular time in the future, based on past observations.

Due to the data accumulated for each subscriber, the system can implement a loyalty program, wherein a subscriber receives a reward after purchasing a predetermined amount from an establishment. This loyalty program can be implemented without requiring the subscriber to carry a loyalty card or other equivalent object.

The present invention therefore has the primary object of providing a system and method for providing information about bars and nightclubs, in a particular vicinity, to a plurality of subscribers.

The invention has the further object of providing information, to subscribers having mobile devices, concerning special offers available at various bars and nightclubs.

The invention has the further object of enabling subscribers to communicate with other subscribers who are located at various bars or nightclubs in a particular geographic area.

The invention has the further object of providing detailed information to operators of bars or nightclubs, concerning their customers.

The invention has the further object of enabling operators of bars or nightclubs, to tailor special offers to selected classes of prospective customers.

The invention has the further object of transmitting special offers to a subscriber when the subscriber is at or near the establishment issuing the special offer.

The invention has the further object of enabling bars, nightclubs or similar establishments to offer loyalty programs to subscribers, wherein the loyalty programs can be effortlessly and automatically implemented.

The invention has the further object of enabling operators of bars or nightclubs, as well as customers of such establishments, to use data accumulated by the system, to predict how many customers will arrive at a bar or nightclub at a particular time.

The invention has the further object of enhancing the entertainment value of bars or nightclubs, for a plurality of subscribers.

The invention has the further object of notifying subscribers concerning activities and events offered by bars or nightclubs, which activities and events relate to interests previously indicated by subscribers.

The invention has the further object of helping operators of bars or nightclubs to optimize their profitability.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 illustrates a screen display, produced by the present invention, showing a profile screen, through which a subscriber provides identifying information to the system.

FIG. 2 illustrates a screen display, generated by the present invention, showing a “home” screen which includes a map of the area in which the subscriber is located, and indicating the numbers of other subscribers in each geographical region.

FIG. 3 illustrates a screen display, generated by the present invention when the subscriber activates “list mode”, to list bars and nightclubs in a region, according to predetermined criteria.

FIG. 4 illustrates a screen display, generated by the present invention, which display appears when the subscriber presses a button in FIG. 3 corresponding to a particular bar or nightclub.

FIG. 5 illustrates a screen display, generated by the present invention, showing what the subscriber sees after pressing a button relating to a special offer by a bar or nightclub.

FIG. 5A illustrates a screen display, generated by the present invention after the subscriber presses the “Redeem Boozpon” button of FIG. 4.

FIGS. 6 and 7 illustrate screen displays, generated by the present invention, which displays appear after a subscriber activates the “patrons” button on the display of FIG. 4.

FIG. 8 illustrates a screen display, generated by the present invention, when the subscriber presses the “favorite bars” button of FIG. 2.

FIG. 9 illustrates a screen display, generated by the present invention, when the subscriber activates the filter, as shown in FIG. 8, the display showing a map indicating the subscriber's favorite bars in the vicinity, and the number of subscribers, who meet the subscriber's criteria, located at each.

FIG. 10 illustrates a screen display, generated by the present invention, shown to a male subscriber who has indicated a desire to meet one or more female subscribers who are within a pre-selected geographical radius.

FIG. 11 illustrates a screen display, generated by the present invention, shown to a female subscriber who has indicated a desire to meet one or more male subscribers within a geographical radius which has previously been selected by the female subscriber.

FIG. 12 illustrates a screen display, generated by the present invention, shown to a female subscriber who has indicated a desire to select the male subscribers who will be allowed to contact her, within a geographical range selected by both male and female subscribers.

FIG. 13 illustrates a screen display, generated by the present invention, the display being populated by females who have indicated a willingness to be seen by a particular male subscriber, shown to the male subscriber, who has previously indicated a desire to meet female subscribers.

FIG. 14 is similar to FIG. 13, but shows a text message exchange between a male and female subscriber, and also shows a button which can be used by a male subscriber to allow a female subscriber to send text messages to him.

FIG. 15 illustrates a screen display, generated by the present invention, as seen by an owner or manager of a bar or nightclub, showing statistics on popular offers and on the customers who used such offers.

FIG. 16 illustrates a screen display, generated by the present invention, as seen by an owner of manager of a bar or nightclub, or of a liquor distributor or distiller, enabling the owner or manager to initiate a special offer to subscribers of the system.

FIG. 17 illustrates a screen display, generated by the present invention, as seen by an owner of manager of a bar or nightclub, or manager of a liquor distributor or distiller, enabling the owner or manager to determine which subscribers receive a particular special offer.

FIG. 18 illustrates a screen display, generated by the present invention, as seen by an owner of manager of a bar or nightclub, enabling the owner or manager to define categories of prospective customers, so as to make special offers to customers satisfying predetermined criteria.

FIG. 19 illustrates a calculation used, in the present invention, to predict how crowded a bar or nightclub will be at a selected time of the day.

FIG. 20 illustrates another aspect of the calculation based on the data shown in FIG. 19.

FIG. 21 provides a diagram showing another feature of the present invention, wherein the system anticipates where a subscriber will be, and is programmed to send special offers to that subscriber, based on the location of the subscriber.

FIG. 22 provides a block diagram of the system of the present invention.

### DETAILED DESCRIPTION OF THE INVENTION

The present invention is a mobile application, made available to users or subscribers through smartphones, tablets, or the like. The invention provides subscribers with information about special offers available at particular establishments, such as bars or nightclubs, within a predetermined geographical area, and about other subscribers who may be located at some of these establishments. The invention also enables owners of the establishments, as well as distributors and distillers of alcoholic beverages, to make special offers, possibly tailored to certain categories of subscribers, and to notify such subscribers either by a text message or by a “pop-up” message generated by the system. The invention also includes the collection, storage, and analysis of statistics related to attendance at these establishments over a period of time.

The practice of the present invention depends critically on the ability to determine automatically the location of a mobile device. The actual details of determining such location do not form part of the present invention, as the prior art is filled with examples of systems for performing this function. Examples of patents which describe systems and methods for determining the location of a mobile device are U.S. Pat. Nos. 8,688,143, 8,108,144, 8,108,414, 8,019,692, 7,848,765, 8,489,127, 8,521,191, 8,781,496, 8,781,505, 9,077,637, 9,503,861, 9,519,065, 9,628,957, 9,832,604, 9,877,243, and 9,942,710, all of the disclosures of which are hereby incorporated herein. The present invention could use methods described in any of the above patents, or it could use other techniques for location determination. The means for determining location, recited in the claims, can therefore be any of the means described in any or all of the above-cited patents, or their equivalents.

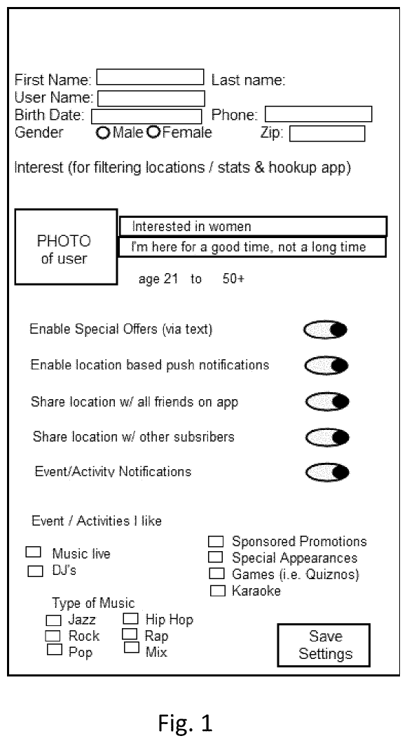

The first step in the use of the present invention, by any subscriber, is registration by the subscriber. The subscriber is presented with a display such as that shown in FIG. 1. The display of FIG. 1 enables the user or subscriber to complete a profile, containing basic information about the subscriber, and information about his or her preferences, for storage by the system. The subscriber's preference may include information regarding the kinds of activities in which the subscriber is interested, and about which the subscriber wishes to be notified, when such activities are offered by a particular nightclub or bar. The subscriber can register with the system directly through a mobile device, or indirectly through intermediaries, such as social media websites exemplified by Facebook or Instagram.

The upper portion of the screen display of FIG. 1 provides spaces for the subscriber to enter his or her name, birth date, phone number, gender, and zip code. The system verifies the phone number by transmitting a text message containing a code, to the subscriber, when the subscriber leaves the profile screen, and requiring the subscriber to enter that code as a means of verifying that the phone number is genuine.

The next area of the screen display of FIG. 1 enables the subscriber to upload a photograph of the subscriber, and to indicate interests. For example, the system may provide the subscriber with various choices, such as “interested in women”, “interested in men”, or “interested in women and men”. A secondary interest, located on the space below that of the primary interest, could be selected from the following or others:

Want a relationship;

Looking for a friend, see what happens;

Don't Know;

I'm here for a good time, not a long time

Following the expression of interests, the screen of FIG. 1 includes several buttons through which the subscriber makes choices. The buttons shown in FIG. 1 include the following:

Enable Special Offers. If the subscriber indicates “yes”, the system will accept offers from various establishments and present the details to the subscriber.

Enable location-based push notifications. If selected, the system will allow general notifications relating to special offers to be delivered to persons in the area of the particular establishment. For example, this feature, when enabled, can cause the subscriber to receive a notification of a special offered by a bar, when the subscriber is walking past that bar.

Share location with all friends on app. If selected, this feature will share the location of the subscriber with the subscriber's “friends”, as will be defined later.

Share location with other subscribers. If selected, this feature allows all other subscribers to the program to know the location of the particular subscriber.

Event/Activity Notifications. This feature allows the subscriber to enter the type of events for which the subscriber wishes to be notified. Below the button there are various activities listed, and the subscriber can select any or all of these. The subscriber also has the opportunity to indicate a preference for one or more types of music, or types of liquor or beer.

When the subscriber presses the “save settings” button, the settings are saved. If the subscriber has changed the phone number, the system executes a verification process, as described above.

The term “friend”, as used in this application, means a connection that has been created between a given subscriber and another subscriber. The system can be programmed to identify “friends” according to any of a large number of criteria. For example, a subscriber can enter the telephone number of a friend, and that friend will receive a notification, requesting that he or she join the service. If the friend joins, then he or she is identified as a “friend” of the referring subscriber. If the friend is already a subscriber to the service, then he or she is simply recognized, i.e. linked, as a “friend” of the referring subscriber. The term “friend” may also include “friends” of a subscriber, as established on a third-party social media platform such as Facebook or Instagram.

The system is preferably configured to provide the option of registration through a social media platform such as Facebook or Instagram. In this case, the system can be programmed to input and/or confirm a profile, and to send a text message with a code for verification.

When a subscriber registers for the system using a social media platform, the system can request the subscriber's permission to notify the subscriber's “friends”, on that platform, via a text message. The system can inform the subscriber that if “friends” in the area join the system, then in addition to knowing the location of friends when visiting bars or nightclubs, the subscriber will also receive incentives such as a coupon from one of such establishments.

If a subscriber has registered through a social media platform, and then visits the profile page on the system, the profile page will pre-populate the display with data relating to that subscriber, and will allow the subscriber to modify the data, if desired. In all cases, if the last phone number entered by the subscriber has not been verified, it will be verified in the manner described above.

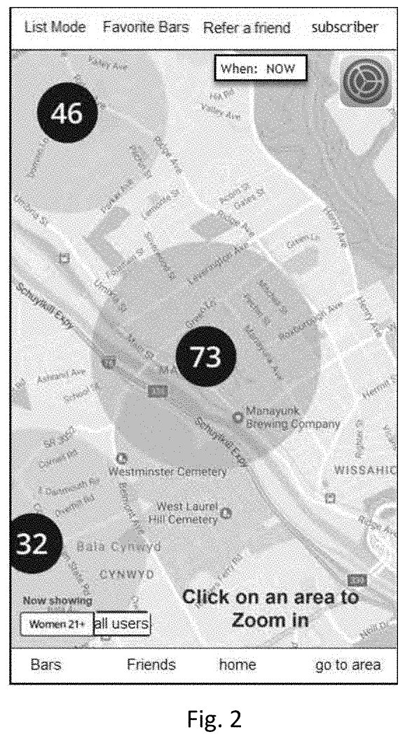

FIG. 2 illustrates a typical “home” screen seen by a subscriber to the system of the present invention. The system is preferably programmed to recommend to the subscriber, when the subscriber selects the home screen, that the subscriber continue to operate the program when going out, so that the subscriber can be made aware of promotions by various nearby bars and nightclubs, and can be made aware of the presence of “friends”, or alternatively the total number of subscribers, in the various geographical regions.

The home screen is designed to position the map so that the zip code, or other geographical identifier, of the subscriber is in or near the center of the screen.

The numbers on the home screen indicate the number of other subscribers in a particular region. The system can simply provide all subscribers in that region, or it can provide the number of subscribers having a common interest with the given subscriber, based on the information entered as part of the subscriber's profile.

The “go to area” button, if pressed and held, allows the subscriber to enter a desired zip code, or to specify “here”, meaning the present location of the device. The system will then place the appropriate map around the location selected.

The “When” button, appearing in the upper portion of the map, allows the subscriber to specify that the system either show current data concerning attendance at various establishments and current specials being offered by such establishments, or that it show attendance data which is anticipated or predicted at a future time (to be shown via a drop-down screen), or information on special offers which will be made available at a future time.

If the subscriber presses the “List Mode” button, the system displays a screen that lists the bars in the selected region. The list screen will be described later.

If the subscriber presses the “Favorite Bars” button, the subscriber will see a list of bars which the subscriber has previously identified as favorites.

If the subscriber presses the “Refer a Friend” button, the subscriber is directed to another screen enabling the subscriber to suggest another person, via a phone number, optionally accessible through the subscriber's address book on the mobile device, as a potential new subscriber to the system.

If the subscriber presses the setup (gear) icon, at the upper right-hand portion of the screen, the subscriber is directed to the profile screen, described above.

If the subscriber presses the “Bars” button, the subscriber will be given the opportunity to search for a bar, as described below.

If the subscriber presses the “Friends” button, the subscriber is given the opportunity to search to determine where his or her friends are located.

If the subscriber presses the “Subscriber” button, the subscriber can search for another subscriber, and can send a “friend” request.

If the subscriber presses one of the black circles, the system will zoom in on the selected geographical area.

The system can be programmed to define various regions within a city, or within a metropolitan area, the regions being defined by GPS coordinates. Such regions will enable the system to decide whether a bar belongs to one or another of the regions. Various rules can be devised for determining the region to which a particular bar or nightclub shall be deemed to belong.

For example, the regions can be identified manually, by those managing the system, or they can be defined algorithmically by segmenting areas based on the “density” of bars. An algorithm can be developed which expands the boundaries of a proposed region until its density of bars is less than or equal to that of a surrounding or nearby region. That is, the algorithm would define regions which have bar densities which are approximately equal.

Also, the numbers of subscribers shown in the display of FIG. 2, could be designed to refer only to subscribers who meet a specific demographic profile. For example, a subscriber may be interested in knowing how many subscribers in his or her age group, are located in each region.

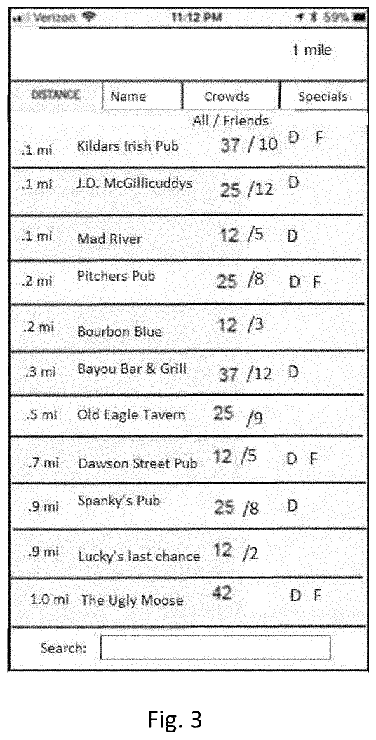

FIG. 3 shows the system in “list mode”, invoked when the subscriber presses the “List Mode” button on the Home screen of FIG. 2.

The default presentation in list mode is a distance view. That is, the system provides a list of bars, ordered by distance from the subscriber, within the range listed, as shown in the upper right-hand corner (the example of FIG. 3 shows the distance as one mile). The display shows a list of bars, the number of total subscribers, and “friends” of the given subscriber, at that bar, and the distance from the subscriber's current location. The subscriber can increase the radius by pressing the distance indicator in the upper right-hand corner, to select a larger radius, which will add bars to the list. That is, when pressed, the “one mile” indication could change to “two miles”, “three miles”, etc.

In the example given in FIG. 3, the closest bar is Kildars Irish Pub, and there are 37 subscribers currently at that bar, of which 10 are the subscriber's “friends”.

The column labeled “Specials” indicates the availability of special offers, either for drinks, in which case a “D” appears, or for food, in which case an “F” is used. Alternatively, the system could use symbols, such as either or both of a martini glass or a knife and fork, to indicate the availability of specials for drinks and food.

The bars in List Mode can be presented in an order based on a criterion other than distance from the subscriber. For example, the system can arrange the bars in alphabetical order by name, by pressing the “name” tag, or according to the number of subscribers at that bar, by pressing the “crowds” tag.

In a variation, one could omit the “Specials” tab, but still provide icons to indicate the availability of special offers.

In an alternative embodiment, the bars and nightclubs shown in the list of FIG. 3 could be shown graphically, on a map of the selected geographic area.

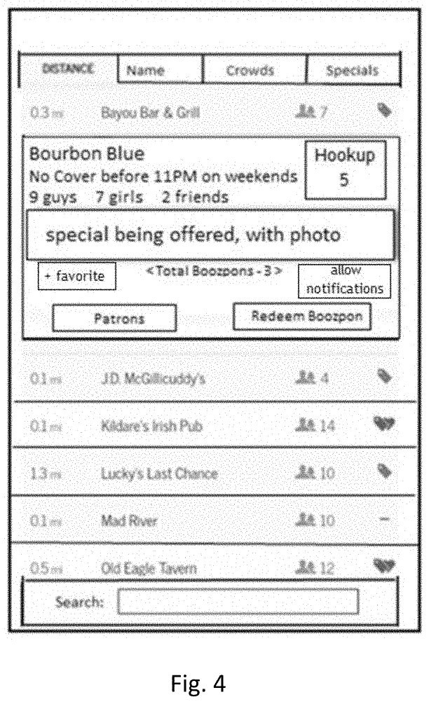

When the subscriber presses the button pertaining to a particular bar or nightclub, in List Mode, the subscriber is then presented with a screen display such as that illustrated by FIG. 4. In the example given, the subscriber has pressed on the bar named “Bourbon Blue”.

The information displayed in FIG. 4 is specific to a selected bar, and shows general information about that bar, specials available at that bar, the number of subscribers at that bar, and the number of pre-designated “friends” at that bar. The system can also show, to male subscribers, the number of female subscribers in the bar who have indicated a desire to meet male subscribers fulfilling certain criteria.

The display illustrated in FIG. 4 includes the name of the bar, and possibly a brief advertisement from the bar. In the example given, the advertisement is “No Cover before 11 PM on weekends”. The screen indicates the number of male and female subscribers present at that bar, and the number of “friends” of the subscriber who are present.

The block labeled “Special being offered, with photo” indicates an advertisement of a special offer, from the selected bar, possibly including a photo provided by that bar. By pressing on the “>” or “<” buttons, the subscriber can step through other specials, if any, offered by that bar.

In the system of the present invention, each bar can provide an electronic coupon, called herein a “Boozpon”. The button in FIG. 4 labeled “Redeem Boozpon” enables the subscriber to view details of a particular Boozpon, and to view other Boozpons being offered by the same establishment. However, the subscriber cannot redeem a Boozpon if he or she is not in the immediate vicinity of the bar.

The “Hook up” button will be grayed out unless the subscriber is in the immediate vicinity of the bar.

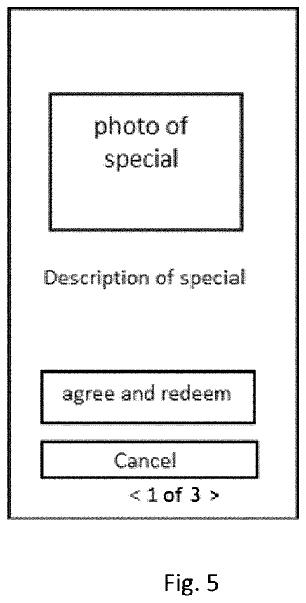

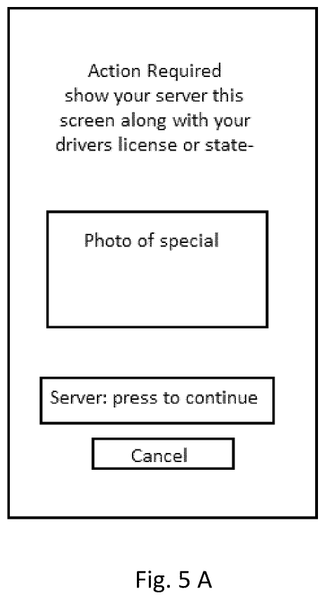

FIG. 5 shows a screen display which offers a Boozpon, which may include a photograph showing or referring to the special offer. If the subscriber wants to redeem this Boozpon, he or she presses the button labeled “agree and redeem”. If not, the subscriber can press an arrow (“<” or “>”) to advance to the next Boozpon.

FIG. 5A shows a screen display generated by the system after the subscriber presses the “Redeem Boozpon” button of FIG. 4. The display may include a photograph illustrating the special offer, and includes an instruction to show the screen to the server. The server can then press the indicated button, and may be instructed to enter information necessary to record the transaction.

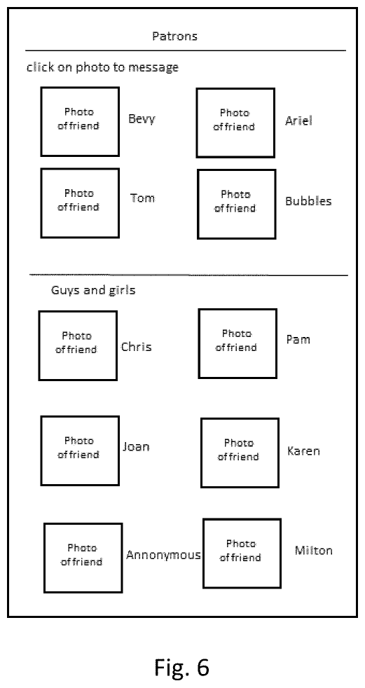

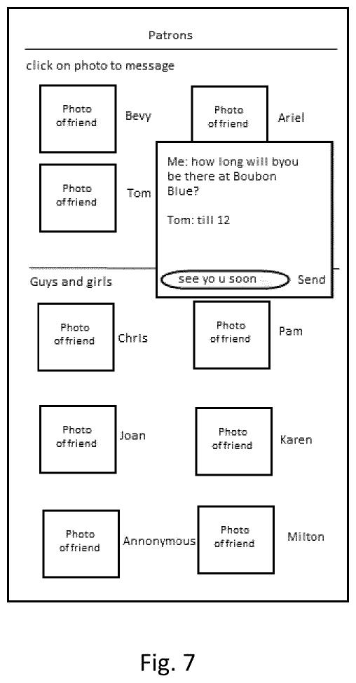

FIGS. 6 and 7 show screen displays, generated by the present invention after the subscriber presses the “patrons” button on the display of FIG. 4. In general, the “patrons” button from FIG. 4 enables the subscriber to see the current patrons at the selected bar, and to communicate with such patrons, provided that the patron is a “friend” or has otherwise indicated a willingness to be contacted by non-friend subscribers.

The screen displays of FIGS. 6 and 7 are divided into upper and lower sections. The upper section identifies patrons in the selected bar whom the subscriber has previously designated as “friends”. The lower section identifies patrons who are subscribers to the system, but who have not become “friends” of the subscriber.

In FIGS. 6 and 7, for all subscribers shown, there is a photograph and a name associated with the photograph. The subscriber may press a selected photograph to send a message to the indicated person. Doing so will open a chat window, illustrated in FIG. 7, through which the subscriber and the selected person can exchange text messages.

The system can be programmed such that subscribers can indicate, for example when establishing a user profile, a desire to be anonymous, unless the subscriber gives permission to reveal his or her identity. If a subscriber has elected to be anonymous, the display in FIGS. 6 and 7 would identify subscribers, in the lower portion of the screen, by number only, or with some other symbol that does not reveal the person's identity.

The system can be programmed to track all subscribers that look at patrons, using the patron button, and to keep track of what such subscribers are viewing.

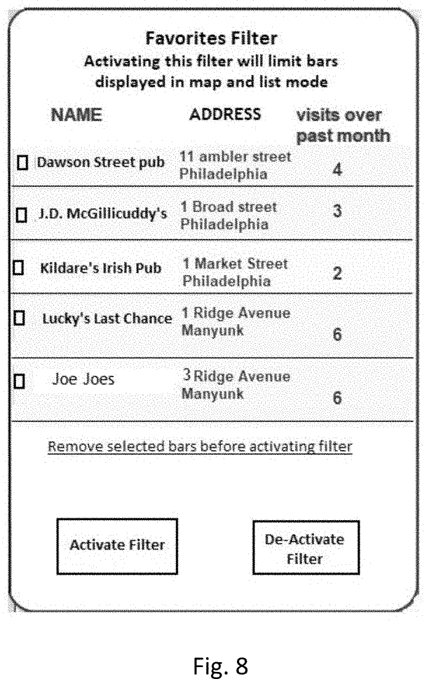

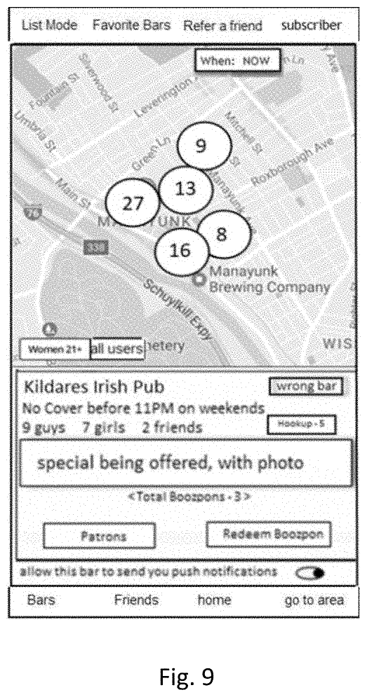

When the subscriber presses the “favorite bars” button, shown on the home screen of FIG. 2, the subscriber is presented with the display shown in FIG. 8. In the example given, the subscriber is shown a list of five bars which had previously been added to the list of “favorite” bars. The subscriber can identify favorites when viewing details of a particular bar. The display shows the number of times the subscriber has visited each bar during the past month. The subscriber may check the boxes at the left-hand side of the name of the bar(s), and then, if the subscriber presses “activate filter”, the subscriber sees a map, similar to that of FIGS. 2 and 9, but showing only those bars that were selected. If the subscriber selects one or more bars, and then presses “remove selected bars”, those bars will be removed from the list of favorites. If the subscriber presses “de-activate filter”, all bars within the geographical area will be shown on the map.

When the subscriber activates the filter, as indicated in FIG. 8, the subscriber then sees the screen display of FIG. 9, which comprises a map indicating the subscriber's favorite bars in the vicinity, and the number of subscribers located at each such bar, who meet the subscriber's criteria. The subscriber's criteria are based on what the subscriber had entered in his or her profile. For example, a subscriber could express an interest in “females 21-55”, in which case the system would display the number of such persons at each of the displayed bars. Alternatively, the subscriber can press the button labeled “all users” to eliminate this filter.

The display of FIG. 9 contains information about the selected favorite bar, including advertising information, promotion of a special offer, and the ability to view patrons or redeem a Boozpon. By touching the “favorite bars” button, the subscriber can navigate back to the favorites filter screen (FIG. 8) and select another favorite bar, in which case the information for that bar will appear in the display of FIG. 9.

The button “wrong bar” in FIG. 9 is used to allow the subscriber to tell the system that it has displayed the wrong bar, when the subscriber believes himself or herself not to be at the establishment being displayed by the system. This issue can possibly result from confusion of the location of one bar with that of another one nearby, due to limitations on the resolution capability of the GPS system or its equivalent. Such input can be used to force the system to display other choices to the subscriber. The function of the “hookup” button will be described later.

An important feature of the present invention is that it facilitates social interactions among subscribers. Specifically, when subscribers wish to meet other subscribers of the opposite sex, they activate a “hook up” or “meet” button.

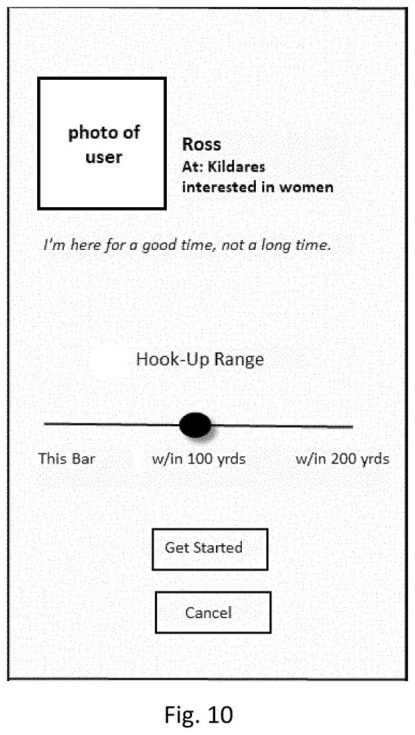

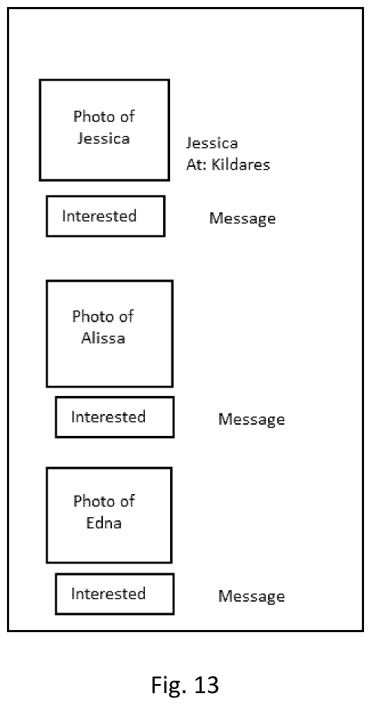

When a male subscriber has pressed the “hook up” button, the subscriber is shown the display of FIG. 10. The subscriber may be asked to pay a small fee before being directed further. As an inducement to further participation, the system may display, to the subscriber, the number of female subscribers in the area, or only those female subscribers in the area who have expressed an interest in hearing from him. The display of FIG. 10 shows a slide bar, which the subscriber can use to specify a geographical range of consideration. That is, the subscriber can indicate, to the system, that he wishes to meet women in the bar or nightclub where the subscriber is located, or within a range, such as 100 or 200 yards. When the subscriber activates the “get started” button, he is directed to FIG. 13, which will be described later.

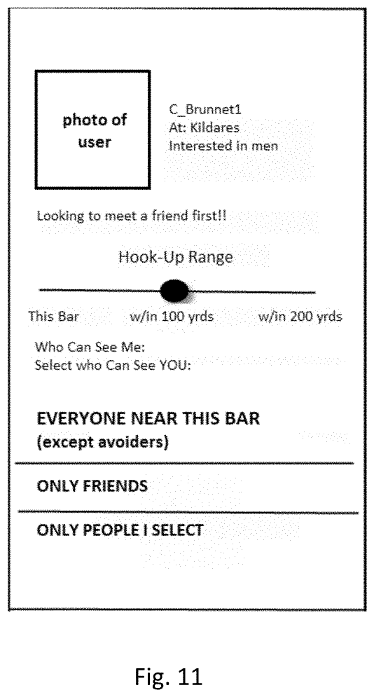

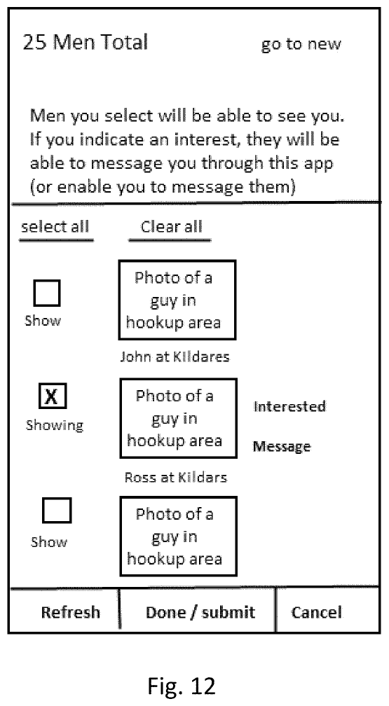

When a female subscriber has pressed the “hook up” button, the subscriber is shown the display of FIG. 11. Like the male subscriber, the female subscriber may indicate a geographical range, using the slide bar. But, in addition, the female subscriber may indicate that she is willing to meet 1) every subscriber in or near the bar in which she is located, 2) every male “friend” in or near the bar in which she is located, or 3) only persons she selects. To use the latter option, the female subscriber presses the “select” button, and is directed to the display shown in FIG. 12.

As shown in FIG. 12, the female subscriber is presented with photographs of male subscribers in the area, and she may select one or more of these, using the boxes at the left-hand side.

If the female subscriber has indicated that she wishes to be seen only by those she has selected, the system will not present any information about her availability to subscribers she does not select. Thus, a male subscriber will not see a photograph, or any other identifying information about a woman, unless that woman has selected “everyone near this bar” (in FIG. 11), or “only friends” (and the male subscriber is already a friend), or unless that woman has specifically selected that male subscriber by selecting the appropriate box in FIG. 12, that she agrees to be available for contact by that subscriber. Note that the female subscriber has the option of not selecting male subscribers, in advance, who will be permitted to make contact, but instead may indicate a willingness to be contacted by any male subscriber in the area. Throughout a night, as men enter the area, the female subscriber will be periodically notified by the system, via a pop-up message, to re-review available men.

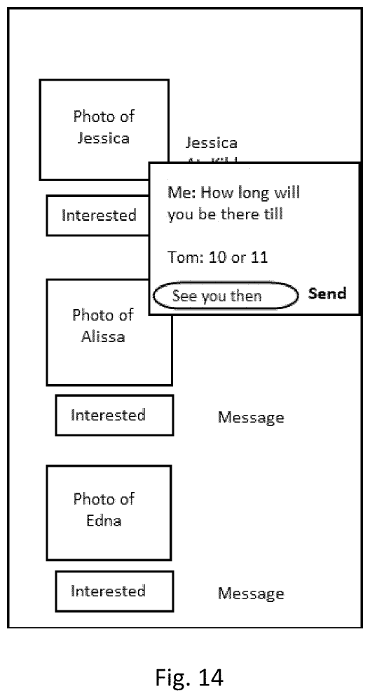

Meanwhile, FIGS. 13 and 14 show displays as seen by male subscribers. In FIG. 13, the male subscriber is presented with photographs of various female subscribers, who have either specifically agreed to be contacted by the male subscriber, or who have allowed contacts by any subscriber. By pressing the “message” button, the male subscriber activates a text window, shown in FIG. 14, and can engage in a text conversation with the selected female subscriber. The button labeled “interested” in FIGS. 13 and 14 can be programmed such that if the male subscriber presses this button, the indicated female subscriber can send a message to the male subscriber.

The system of the present invention is dynamic, in that male and female subscribers will likely continuously enter and exit a particular bar or nightclub during the course of a day or evening. Thus, the number of subscribers, depicted on the maps shown by the system, for each location, during the course of an evening, will continually change, and the system will present updated statistics to subscribers on a substantially continuous basis. The system can be programmed to provide a message to male subscribers, indicating that the number of female subscribers, who have expressed an interest in the male subscriber, has changed since the last report.

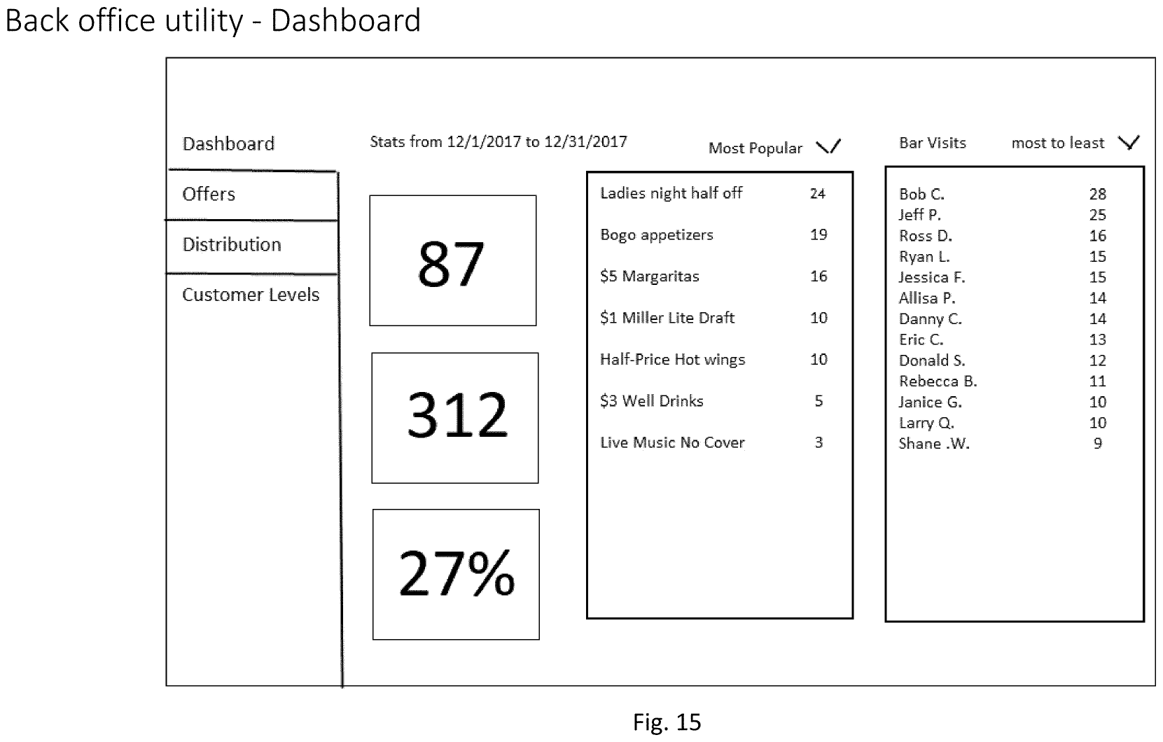

FIGS. 15-18 provide screens representing the “dashboard” seen by owners or managers of bars or nightclubs who are participants in the present system. It should be appreciated that virtually all of the data shown in these figures, relating to statistics about customers patronizing various establishments, are available because the system continuously monitors the location of each subscriber, and the actions taken, on the system, by each subscriber, at each given time, on each particular night. All of such information is stored by the system, and later analyzed, as exemplified by the displays described below.

FIG. 15 shows a display which comprises a “back office utility”, showing the total number of special offers received by subscribers during a selected period, such as one year, and the total number of persons who have visited the bar or nightclub during that period, while operating the program of the present invention. In the example of FIG. 15, there have been 312 subscribers who entered the bar, of which 87 redeemed a special offer, for a percentage of 27%. The display also lists the various promotions, in order of most popular (i.e. the number of subscribers who redeemed each offer) and the number of subscribers who redeemed each one. As shown in FIG. 15, the sum of these numbers is 87, in the example given. The display at the right-hand side lists the “best” customers, i.e. subscribers presented according to the number of visits to the bar or nightclub during the relevant period.

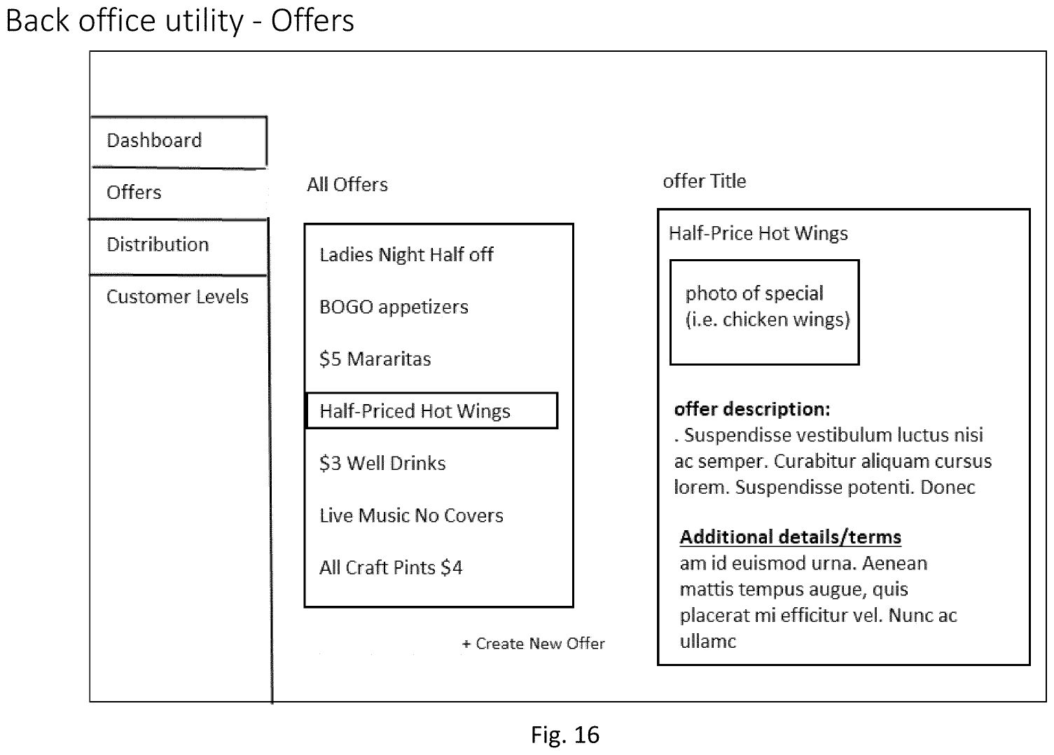

FIG. 16 shows a display illustrating the creation of a special offer. The existing offers are listed, and the operator can press one of them to see a display of information about the offer on the right-hand side. The information may include a photograph, and may contain a description of the offer, and additional details or terms. The operator may edit the information shown in this portion of the display. The operator may also create a new offer by pressing the indicated button, and by entering new information into a box similar to the box on the right-hand side of FIG. 16. By selecting an offer, or by creating a new offer, the operator thereby creates a Boozpon, mentioned in the above description.

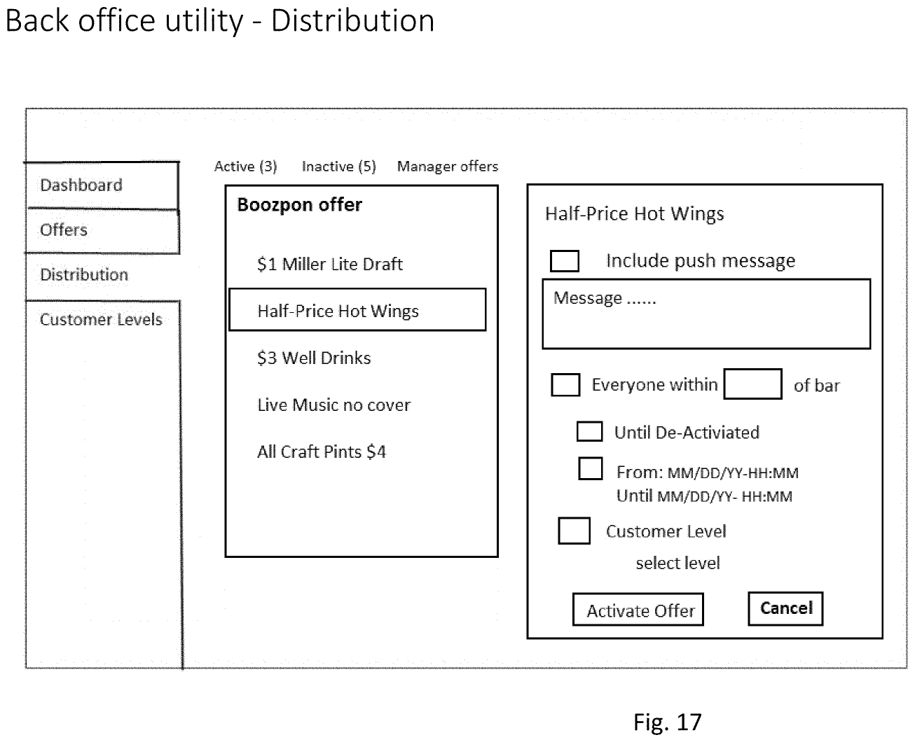

FIG. 17 shows a display illustrating another back-office function, namely the distribution of special offers to potential customers. The display lists various offers previously created by the bar owner. The owner selects one of these offers, and then makes selections in the right-hand portion of the screen. The offer can be delivered to all subscribers, or only to subscribers within a specified distance from the bar, or to all customers at or above a specified level (which will be discussed below). The owner can also control the timing of the offer, making it valid until deactivated, or making it valid within a specified window of time.

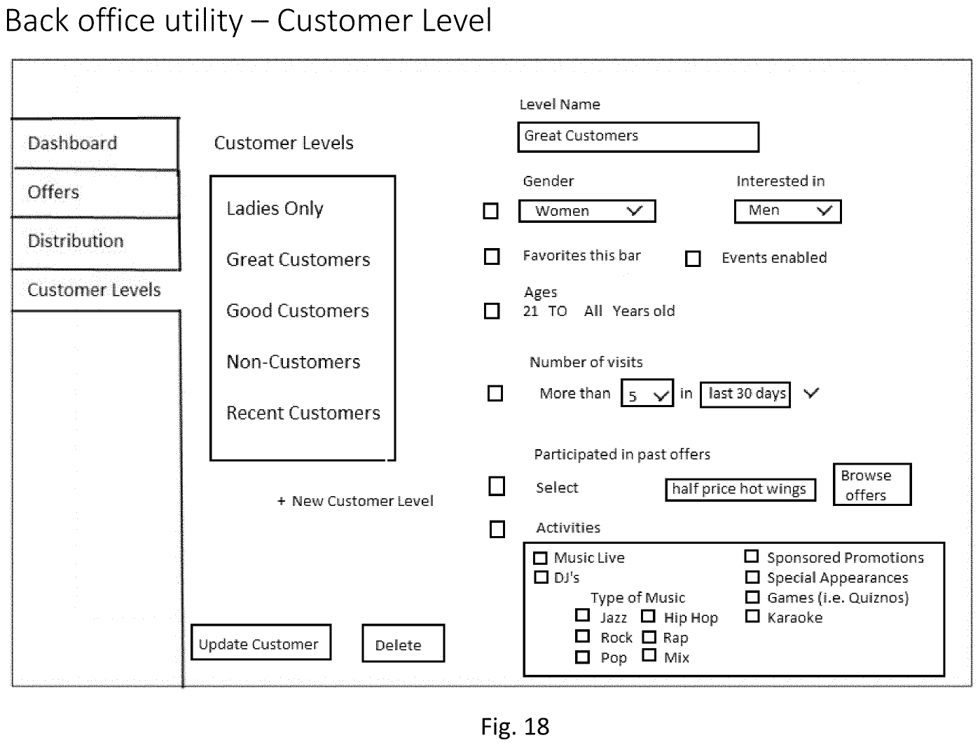

FIG. 18 shows a display illustrating the creation of customer levels. This is another back-office function, enabling the owner of the bar or nightclub to define levels or classes of customers, according to various criteria, for use in distributing special offers. The system can segment potential customers who have never been to the bar, by gender, by events for which the subscribers have indicated a preference, by age, or by number of visits to the bar in a specified period of time. The owner can later direct offers to one or more of these pre-defined levels or classes.

Another feature of the present invention is that it facilitates the implementation of loyalty programs, wherein subscribers are rewarded, in some way, for patronizing particular establishments.

Although loyalty programs have been known in the prior art, they have generally required that the customer obtain a card, or similar object, for use in implementing the loyalty program. For example, it has been known to provide a simple card made of stiff paper, which is punched each time the user patronizes an establishment. When a predetermined number of punches are accumulated, the customer receives a “free” award, such as a free drink or other item. Similar programs have been implemented with cards having magnetic media.

In the present invention, a loyalty program can be implemented without requiring a subscriber to carry a physical card or other object. Since the system keeps records of what establishments are patronized by each subscriber, and of what the subscriber purchases in each establishment, a loyalty program can be implemented without significant effort.

For example, the owner of a bar or nightclub can offer a reward to customers who have patronized the establishment a certain number of times, or who have patronized the establishment at preferred times of the day. The owner may send a message to subscribers, such as, “buy fifty dollars worth of food or drinks and get one drink free”. The system is easily programmed to keep track of when a subscriber meets the criteria for receiving a reward, and for notifying the subscriber that an award is available to be taken.

In summary, the system is programmed to enable owners of establishments to determine criteria of eligibility for rewards, and to communicate such offers to subscribers. By using the data already in its memory, relating to when and where each subscriber has been, the system can automatically keep track of when a particular subscriber has accumulated enough visits or purchases to qualify for a reward. Thus, the loyalty program does not require a card or other similar object, but can be implemented directly within the system, and communicated through the subscriber's mobile device.

The creation of customer levels, illustrated in FIG. 18, can therefore form the basis of one or more loyalty programs. The act of directing offers to a class of potential customers by definition creates and implements a loyalty program.

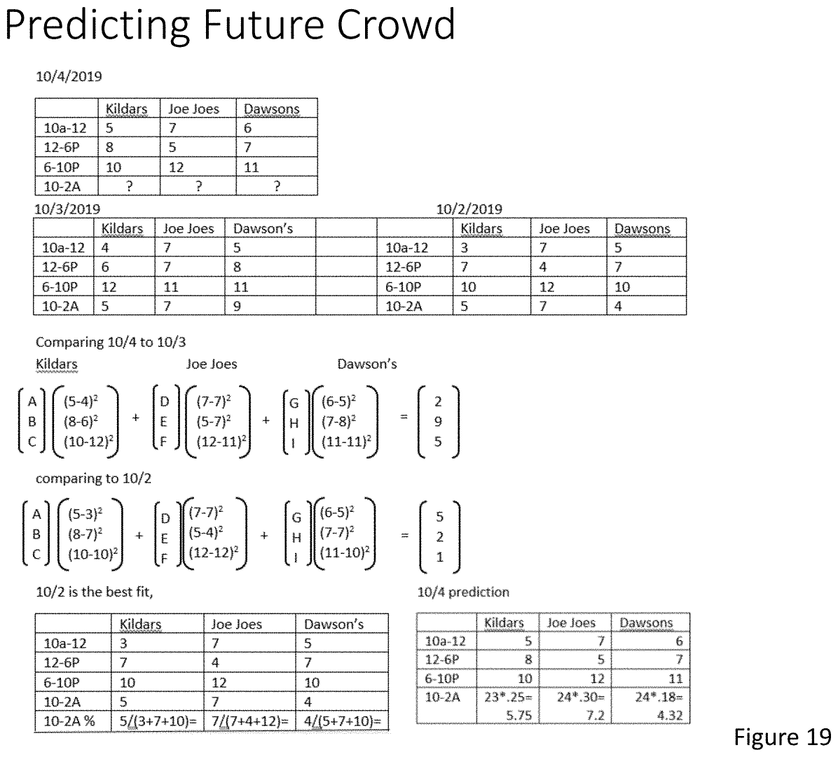

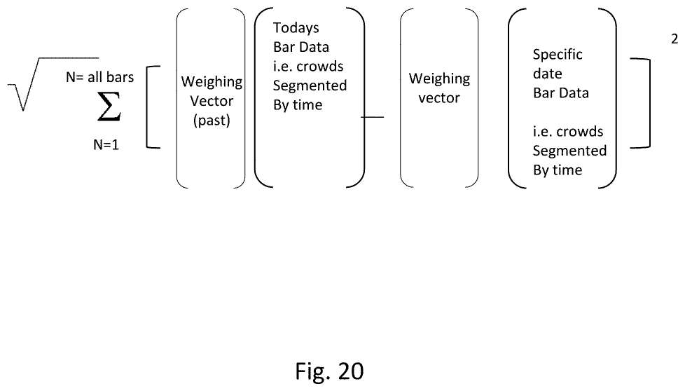

FIGS. 19 and 20 illustrate an algorithm, used in the present invention, to predict how many customers will be in a particular bar or nightclub, based on how many customers have been there throughout the day. The prediction is based on tracking the number of subscribers in all of the bars for a given day, during the entire history of the system, and by how much the business done by a particular bar increased on those days with a similar number of customers. The details of the algorithm are described below.

First, one creates crowd vectors, or their equivalents, for every bar for every day. One tracks the date, the number of subscribers present during a given time interval, and possibly the special circumstances for that day, such as, for example, the next day being a holiday or weekend, the presence of a storm, or the availability of certain special offers.

Having assembled vectors for each bar, for each time interval of each day, one compares attendance data for a given bar with similar attendance data for all the other days, and/or for all bars in the database. The analysis can use a least squares technique, which is illustrated in FIG. 20. FIG. 20 shows that one takes the square root of the sum of the squares of the differences between today's measured data, possibly weighted by a factor to be determined, and the stored data, for comparable time intervals. The weighting that results in the best fit, i.e. the smallest value of the square root of the sum of the squares, determines the day in the past that is predicted to resemble the pattern of the present day.

FIG. 19 provides a highly simplified numeric example to illustrate the above-described algorithm. In the example of FIG. 19, there are three bars, namely Kildars, Joe Joes, and Dawsons. A matrix is formed, for each day in the history of the application, showing the number of customers present during each of several two-hour time intervals. In the simplified example of FIG. 19, the system is deemed to be three days old, the present day is deemed to be 10/4/19, and the two days in the past are 10/2/19 and 10/3/19. In general, one can operate the algorithm using all past data generated by the application.

Thus, on October 2, at Kildars, there are three customers between 10 AM and 12 Noon, seven customers between 12 Noon and 6 PM, 10 customers between 6 PM and 10 PM, and five customers between 10 PM and 2 AM. The numbers of customers, for the same date and the same time periods, at Joe Joes, are seven, four, twelve, and seven, respectively.

As shown in FIG. 19, the object is to predict the number of customers at the three bars, during the time period between 10 PM and 2 AM on October 4.

To answer the above question, one compares the matrix of customers for the present day (10/4) with corresponding matrices for two days in the past (10/2 and 10/3). This comparison can be done by taking the squares of the differences between corresponding matrix elements, and possibly weighting the results by factors labeled A-I. For the present calculation, assume that all of these factors are one.

As shown in FIG. 19, we compare 10/4 to 10/3 by computing the vector sum of the difference vectors for each bar. That is, for Kildars, there are five customers on 10/4 and four customers on 10/3, during the time period from 10 AM to 12 Noon. We therefore obtain (5-4), and square the result. The same procedure is done for all available data for each bar, for each time period. The result is a vector having elements (2, 9, 5). The square root of the sum of the squares of these elements is about 10.49.

The procedure is repeated by comparing the data of 10/4 to the data of 10/2. The result is a vector having elements (5, 2, 1). The square root of the sum of the squares of these elements is about 5.48.

Therefore, using this methodology, one considers 10/2 to be a better fit than 10/3, because the magnitude of the comparison vector is smaller.

One then uses 10/2 to predict the number of customers for 10/4. In the example of FIG. 19, one takes the data for 10/2, and divides the number of customers during the period 10 PM to 2 AM (five) by the total number of customers at that bar for all prior periods during that day (3+7+10), yielding a factor of 0.25. One then multiplies the number of customers observed at Kildars on 10/4 (i.e. 5+8+10=23) by the computed factor of 0.25, to obtain the result 5.75. Thus, the algorithm predicts that there will be about six customers during the time period of 10 PM to 2 AM. Similar calculations are performed for each of Joe Joes and Dawsons, to obtain the predicted values shown in the matrix at the lower right-hand portion of FIG. 19.

FIG. 20 represents the basic calculation of a least squares deviation, and shows a general calculation, of which the procedure described above is just one specific example.

As noted above, the weighting factors A-I could have values other than one. Using available computation techniques, one can analyze the data to find weighting factors which appear to be most appropriate.

Also, it should be understood that the procedure described above is only one of many possible algorithms for analyzing the data. Methods other than least squares could be used. Also, the calculation of predicted customer counts could be performed differently. For example, one could determine a percentage change in the customer count from one period to the next, and could apply that percentage change to the current day.

In general, and regardless of the specific algorithm used, the prediction of a customer count for a particular time period, at a particular bar, is based on historical data for that bar, and/or historical data for other bars.

The algorithm which predicts how crowded a particular establishment will be, can be used both by owners of the establishments, and by subscribers to the system.

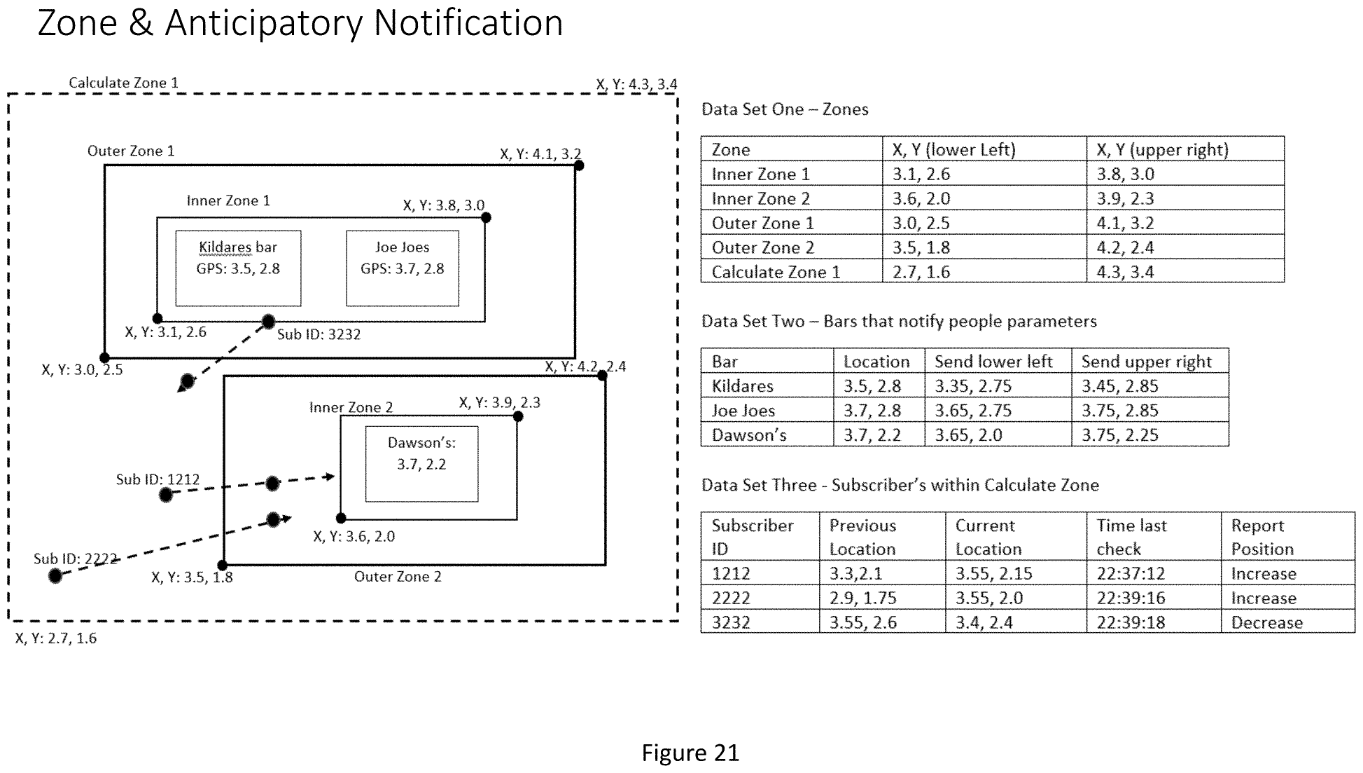

FIG. 21 provides a diagram illustrating another feature of the present invention. In brief, this feature comprises notifying subscribers when they are close to, or in the immediate vicinity of, an establishment offering a particular special. Although the system could be programmed simply to calculate the distance of each subscriber from each bar in the system, such a method would require considerable computation, and would increase the response time of the system. Instead, the preferred method is as described in the following paragraphs.

The system is programmed to identify four “zones”, namely, a “send” zone, an “inner” zone, an “outer” zone, and a “calculate” zone. When a subscriber is within a “send” zone, the system sends a message to the subscriber, the message describing a special offer from an establishment which is within the “send” zone, and which is therefore very close to the subscriber.

When the subscriber is within an “inner” zone, the subscriber is deemed to be located within a broader area, where the subscriber may be close to one of several establishments wishing to send information about special offers. Also, when the subscriber is in the “inner” zone, the system is programmed to check bars more frequently in that zone to determine whether a promotional message should be sent to the subscriber.

When the subscriber is in the “outer” zone, the system determines the current location, and previous location, of the subscriber, and thus determines in what direction the subscriber appears to be moving. If the subscriber is moving in the direction of an “inner” zone, the system will check the location of the subscriber on a more frequent basis, to be ready to send the subscriber a notification concerning special offers.

If a subscriber is outside a “calculate” zone, the subscriber is too far away from any of the establishments participating in the system, and the system will reduce the frequency with which the location of the subscriber will be monitored.

The approach described above thus conserves computing power by eliminating the need to do a distance calculation to determine when to send a message. It also reduces the time necessary to notify a subscriber of a special offer. Thus, with the present system, it is more likely that a subscriber will respond to special offers as they approach a particular establishment.

The above-described procedure is implemented as follows. The system stores three data sets, in the form of tables. The first data set will store the definition of the zones. Preferably, one can use GPS coordinates, or latitude and longitude, or some other equivalent means of identifying locations.

The second data set will store the coordinates of each establishment wishing to make special offers to subscribers. The second data set includes parameters of the “send” zone relative to the particular establishment, and identifies the location of each establishment. The zone size and location could change throughout a night, depending on volume of business in each zone.

The third data set lists the current and previous location for every subscriber, the data being limited to those subscribers who are within the boundaries of the “calculate” zone.

A simplified numerical illustration is presented at the left-hand side of FIG. 21. In this example, coordinates designating the locations of the various zones, bars, and subscribers, are presented in hypothetical units. In practice, actual coordinates could be defined by latitude and longitude, or by some other definition. Note also that the drawing is not necessarily drawn to scale, but is intended to illustrate the general concept.

In FIG. 21, Kildares bar is located at a point defined by coordinates (3.5, 2.8), Joe Joes is located at (3.7, 2.8), and Dawson's is located at (3.7, 2.2).

All of the above-mentioned bars are located within Calculate Zone 1, defined by coordinates (2.7, 1.6) at the lower left-hand corner, and coordinates (4.3, 3.4) at the upper right-hand corner. Within Calculate Zone 1, there are two outer zones, namely Outer Zone 1, having corner coordinates of (3.0, 2.5) and (4.1, 3.2), and Outer Zone 2, having corner coordinates of (3.5, 1.8) and (4.2, 2.4).

In the example given in FIG. 21, there are three subscribers, identified by codes 1212, 2222, and 3232. The current and previous locations of subscriber 1212, for example, indicate that the subscriber has moved into Outer Zone 2, and may be moving into Inner Zone 2. The same is true for subscriber 2222. On the other hand, subscriber 3232 is moving away from Inner Zone 1, and out of Outer Zone 1.

As explained above, the position of the subscriber relative to the various zones around the bars determines the frequency at which the position is checked. In general, the closer the subscriber approaches a bar, the more frequently the position of the subscriber will be monitored, so that the system can generate a special offer when the subscriber is very close to a particular bar.

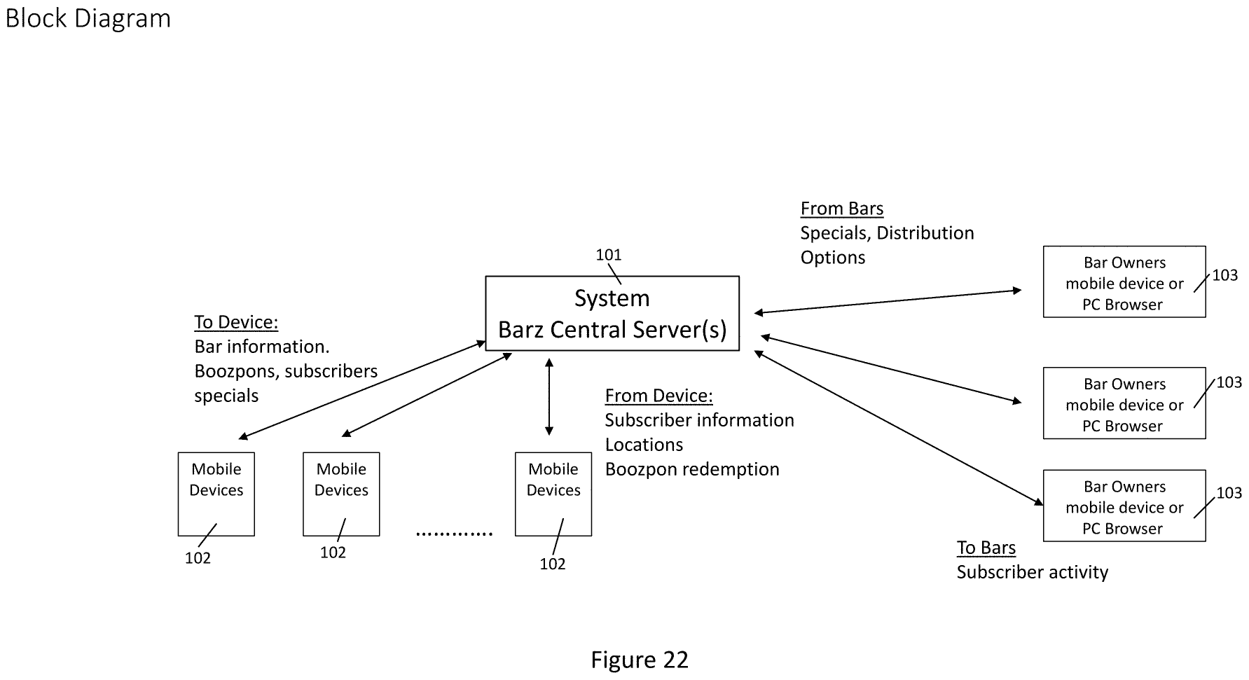

FIG. 22 provides a block diagram of the system of the present invention. The system includes a central server 101 which communicates with mobile devices 102, belonging to the various subscribers, and which also communicates with mobile devices or computers 103, belonging to the owners of bars or nightclubs who are participants in the system. The server is a programmed computer, programmed to execute the steps outlined above. The communication between the server and the mobile devices and/or computers is preferably conducted over the Internet. Other means of arranging the hardware used in the present system, or of communication between devices, could be used, within the scope of the present invention.

The invention can be modified in various ways which will be apparent to those skilled in the art. The exact configuration of the server, the mobile devices, and computers, can be varied. For example, the function of the central server could be performed by a mobile device or personal computer, provided that it has sufficient memory and speed. The method of monitoring geographical locations of subscribers can be changed. For example, the location of a mobile device could be determined by triangulation of signals from nearby cellular towers. These and other modifications should be considered within the spirit and scope of the following claims.

What is claimed is:

1. A system for providing information about nightclubs or bars in a vicinity, comprising:
a server including a programmed computer,
the server being programmed to receive and store information from a plurality of subscribers, such information including a subscriber profile,
the server also being programmed to receive and store data from a plurality of operators of bars or nightclubs, such data including details concerning said bars or nightclubs,
wherein each subscriber has a programmable mobile device, each mobile device including means for determining a location of such mobile device,
wherein the server is programmed to transmit, to mobile devices of subscribers, information about bars or nightclubs located within a predetermined distance from such mobile device.

2. The system of claim 1, wherein the server is programmed to keep track continuously of a location of each mobile device, said location being transmitted to the server from each mobile device, and to update information, transmitted to each mobile device, concerning bars or nightclubs located within a predetermined distance from such mobile device at a given moment.

3. The system of claim 2, wherein the server is programmed to accept, from subscribers, designations of preferred criteria for bars or nightclubs, and to display to mobile devices of such subscribers information on bars or nightclubs which satisfy criteria set forth by a respective subscriber.

4. The system of claim 2, wherein the server is programmed to display, to a mobile device of a subscriber, information concerning other subscribers who are located at bars or nightclubs within a predetermined distance of the subscriber.

5. The system of claim 2, wherein the server is programmed to enable a given subscriber to restrict an ability of other subscribers to obtain information about the given subscriber.

6. The system of claim 4, wherein the server is programmed to enable a subscriber to identify another subscriber as a “friend”, and wherein the server is programmed to display, to a subscriber, information about “friends” who are located at bars or nightclubs within a predetermined distance of the subscriber.

7. The system of claim 6, wherein the server is programmed to enable subscribers to communicate, by text message, with other subscribers, through their mobile devices.

8. The system of claim 1, wherein the details concerning bars or nightclubs include details of special offers to prospective customers, and wherein the server is programmed to transmit information, on said special offers, to mobile devices of subscribers located within a predetermined distance of a bar or nightclub making such special offer.

9. The system of claim 8, wherein the server is programmed to track movements of each subscriber, and to determine whether a subscriber is moving towards a particular bar or nightclub, the server also being programmed to monitor a location of a subscriber at increasingly shortened time intervals when the subscriber is determined to be moving towards a particular bar or nightclub.

10. The system of claim 8, wherein the server is programmed to transmit, to mobile devices of subscribers, an electronic coupon for use in obtaining a discount on products or services offered by a bar or nightclub.

11. The system of claim 1, wherein the server is programmed to enable said operators to transmit special offers to mobile devices of subscribers.

12. The system of claim 11, wherein the server is programmed to enable said operators to store said special offers for re-use later, and to formulate new special offers, and to establish criteria to determine which subscribers will receive a given special offer.

13. The system of claim 1, wherein the server is programmed to enable said operators to view statistics concerning how many subscribers patronized a bar or nightclub during a predetermined interval of time.

14. The system of claim 13, wherein the server is programmed to enable said operators to view statistics concerning how many subscribers redeemed special offers at a particular bar or nightclub, during a predetermined interval of time.

15. The system of claim 1, wherein the server is programmed to enable said operators and subscribers to predict how many subscribers will patronize a particular bar or nightclub, based on past observations of subscriber attendance data.

16. The system of claim 1, wherein the server is also programmed to store information concerning purchases made by each subscriber at each of said bars or nightclubs, and wherein the server is programmed to implement a loyalty program wherein a subscriber receives a reward after making a predetermined amount of purchases at a particular bar or nightclub, the loyalty program being configured such that the subscriber does not need to carry a card or other object relating specifically to the loyalty program, wherein the server determines automatically when a subscriber is eligible for a reward.

17. A method for providing information about nightclubs or bars in a specific vicinity, comprising:
receiving information from a plurality of subscribers using mobile devices, and storing said information in a memory, said information including a subscriber profile,
receiving data from a plurality of operators of bars or nightclubs, and storing said data in a memory, wherein said data includes details concerning said bars or nightclubs,
continuously determining a location of each mobile device associated with each subscriber, and
transmitting, to mobile devices of subscribers, information about bars or nightclubs located within a predetermined distance from such mobile device.

18. The method of claim 17, further comprising the step of continuously updating information transmitted to each mobile device, concerning bars or nightclubs located within a predetermined distance from such mobile device at a given moment.

19. The method of claim 18, further comprising accepting, from subscribers, designations of preferred criteria for bars or nightclubs, and transmitting, to mobile devices of such subscribers, information on bars or nightclubs within a predetermined distance, which bars or nightclubs satisfy criteria set forth by a respective subscriber.

20. The method of claim 18, further comprising the step of transmitting, to a mobile device of a subscriber, information concerning other subscribers who are located at bars or nightclubs within a predetermined distance of a given subscriber.

21. The method of claim 18, further comprising the step of restricting an ability of subscribers to obtain information about a given subscriber, upon request of said given subscriber.

22. The method of claim 20, further comprising the steps of enabling a subscriber to designate another subscriber as a “friend”, and transmitting, to mobile devices of subscribers, information about “friends” of a given subscriber who are located at bars or nightclubs within a predetermined distance of the given subscriber.

23. The method of claim 22, further comprising the step of enabling subscribers to communicate, by text message, with other subscribers, through their respective mobile devices.

24. The method of claim 17, wherein the details concerning bars or nightclubs include details of special offers to prospective customers, and wherein the method further comprises the step of transmitting information, concerning said special offers, to mobile devices of subscribers located within a predetermined distance of a bar or nightclub making such special offer.

25. The method of claim 24, further comprising tracking movements of each subscriber, and determining whether a subscriber is moving towards a particular bar or nightclub, and monitoring a location of a subscriber at increasingly shortened time intervals when the subscriber is determined to be moving towards a particular bar or nightclub.

26. The method of claim 24, further comprising the step of transmitting, to mobile devices of subscribers, an electronic coupon for use in obtaining a discount on products or services offered by a bar or nightclub.

27. The method of claim 26, wherein the step of transmitting an electronic coupon is performed such that the coupon is transmitted only to subscribers who satisfy predetermined criteria.

28. The method of claim 17, further comprising the steps of continuously storing information concerning which subscribers patronize which bar or nightclub at various times, displaying said information to operators of each said bar or nightclub, and using said information to determine which users will receive special offers.

29. The method of claim 28, further comprising the steps of storing information about subscribers who redeemed special offers at each bar or nightclub. and displaying said information to operators of each said bar or nightclub.

30. The method of claim 17, further comprising the steps of continuously storing information concerning which subscribers patronize which bar or nightclub at various times, and using said information to predict how many subscribers will patronize a particular bar or nightclub, based on past observations of subscriber attendance data.

31. The method of claim 17, further comprising the steps of storing information concerning purchases made by each subscriber at each of said bars or nightclubs, and implementing a loyalty program wherein a subscriber receives a reward after making a predetermined amount of purchases at a particular bar or nightclub, the loyalty program being configured such that the subscriber does not need to carry a card or other object relating specifically to the loyalty program, wherein the server determines automatically when a subscriber is eligible for a reward.

32. A method for providing information about nightclubs or bars in a vicinity, comprising:
receiving information from a plurality of subscribers using mobile devices, and storing said information in a memory, said information including a subscriber profile,
receiving data from a plurality of operators of bars or nightclubs, and storing said data in a memory, wherein said data includes details concerning said bars or nightclubs,
continuously determining a location of each mobile device associated with each subscriber, and
transmitting, to mobile devices of subscribers, information about bars or nightclubs located within a predetermined distance from such mobile device,
further comprising the step of continuously updating information transmitted to each mobile device, concerning bars or nightclubs located within a predetermined distance from such mobile device at a given moment,
further comprising the step of transmitting, to a mobile device of a subscriber, information concerning other subscribers who are located at bars or nightclubs within a predetermined distance of a given subscriber,
wherein the details concerning bars or nightclubs include details of special offers to prospective customers, and wherein the method further comprises the step of transmitting information, concerning said special offers, to mobile devices of subscribers located within a predetermined distance of a bar or nightclub making such special offer,
further comprising tracking movements of each subscriber, and determining whether a subscriber is moving towards a particular bar or nightclub, and monitoring a location of a subscriber at increasingly shortened time intervals when the subscriber is determined to be moving towards a particular bar or nightclub,
further comprising the steps of storing information concerning purchases made by each subscriber at each of said bars or nightclubs, and implementing a loyalty program wherein a subscriber receives a reward after making a predetermined amount of purchases at a particular bar or nightclub, the loyalty program being configured such that the subscriber does not need to carry a card or other object relating specifically to the loyalty program, wherein the server determines automatically when a subscriber is eligible for a reward.
